(19) United States
(12) Patent Application Publication
(10) Pub. No.: US 2007/0217046 A1
(43) Pub. Date: Sep. 20, 2007

(54) Magnetic pattern replication method and magnetic pattern replication apparatus

(75) Inventors: Yutaka Nakamura, Kawasaki (JP); Sumio Kuroda, Kawasaki (JP); Hiroyuki Suzuki, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/455,793

(22) Filed: Jun. 20, 2006

(30) Foreign Application Priority Data
Mar. 17, 2006 (JP) 2006-73636

(51) Int. Cl. G11B 5/86

(52) U.S. Cl. 360/17

(57) ABSTRACT

Magnetic pattern replication method and apparatus suitable for high-density, compact small diameter magnetic recording medium, and for which a master information carrier are proposed. The magnetic pattern replication method includes the steps of forming on one surface of the master information carrier a plurality of magnetic patterns corresponding to the information that is to be recorded on the disk-shaped magnetic recording medium having a diameter smaller than that of said master information carrier; bringing into contact and aligning said magnetic recording medium with the respective plurality of magnetic patterns formed on one surface of said master information carrier; and applying direct current magnetic fields corresponding respectively to said plurality of magnetic patterns to transfer said plurality of magnetic patterns formed on the master information carrier onto said contacting and aligned disk-shaped magnetic recording media corresponding to the respective said magnetic patterns.

### CROSS-REFERENCE TO RELATED APPLICATIONS

This application is based upon and claims the benefit of priority from the prior Japanese Patent Application No. 2006-73636, filed on Mar. 17, 2006, the entire contents of which are incorporated herein by reference.

### BACKGROUND OF THE INVENTION

1. Field of the Invention

The present invention relates to a magnetic pattern replication method which uses a master information carrier on which a patterned magnetic layer corresponding to the information is formed and magnetically transfers the aforementioned information to a magnetic recording medium, and to a magnetic pattern replication apparatus that applies this method.

2. Description of the Related Art

The recording density of compact, large volume magnetic recording medium apparatuses has increased over the years because of capacity increases, and for this reason, it has become difficult to use specialized apparatuses to prepare servo information on the magnetic recording medium for determining head position with mechanical precision. Moreover, a method to easily prepare high-precision position determination information is necessary in order to keep down production costs.

FIG. 1 schematically indicates the upper surface of a disk of magnetic recording medium in a magnetic recording medium apparatus.

A master information pattern 2, which is servo information used for head position determination of every specified angle on the circumference, has been recorded on a magnetic recording medium 1, which is the magnetic recording medium. As indicated in FIG. 2, which is the enlargement of the circled part in FIG. 1, the master information pattern 2 has a clock signal I, a tracking servo signal II and an address information signal III, and a data region IV is positioned on both sides. Further, FIG. 2 indicates only 10 track portions of the magnetic recording medium 1 in a radial direction.

Using a master information carrier to transfer a magnetic pattern corresponding to the master information pattern 2 onto a magnetic recording medium is a known method of forming the magnetic recording medium 1 on the related master information pattern 2 (for example, Japanese Patent Application Publication No. H10-40544 and Japanese Patent Application Publication No. 2003-272143).

The conventional method of replicating a magnetic pattern on a magnetic recording medium described in Japanese Patent Application Publication No. H10-40544 and Japanese Patent Application Publication No. 2003-272143 will be explained next using FIG. 3 and FIG. 4.

FIG. 3 is a conceptual perspective drawing of a magnetic pattern replication apparatus using the conventional method of replicating magnetic patterns disclosed in the aforementioned Japanese Patent Application Publication No. H10-40544 and Japanese Patent Application Publication No. 2003-272143. FIG. 4 is a conceptual diagram of the cross-section along the A-A′ line in FIG. 3.

Master information carrier 10, which has magnetic material parts patterned corresponding to the master information pattern 2, is brought into contact with the magnetic recording medium 1, on which a uniform initial magnetization (dotted line arrow in FIG. 4) is formed. To heighten the transfer efficiency, a direct current excitation magnetic field AMD is applied from a magnet 11, etc. from outside.

Then, because a direct current excitation magnetic field AMD must be applied along the entire circumference of the master information carrier 10 relative rotational movement takes place between the master information carrier 10 and the magnet 11 as indicated in FIG. 3.

### SUMMARY OF THE INVENTION

Here, as demand increases for more compact hard disk apparatuses for recording data and reading out the same, every year magnetic recording media, which is used in a hard disk apparatus, are made higher density and smaller diameter, and therefore, a magnetic pattern replication method and apparatus suitable for compact disks, such as one (1) inch diameter disks, is thereby required.

In the prior art indicated in Japanese Patent Application Publication No. H10-40544 and Japanese Patent Application Publication No. 2003-272143 above, magnetic transfer is conducted for every magnetic recording medium. In particular, in the examples indicated in FIG. 3 and FIG. 4, in order to make both surfaces of magnetic recording medium recording surfaces, large excitation magnets must be arranged on both sides of the magnetic recording medium, and a mechanism to rotate the magnets circumferentially in the RD direction is necessary.

Arrangement of the magnetic recording medium between the excitation magnets of the magnetic pattern replication apparatus thereby poses problems, the discharge mechanism becomes complicated, and magnetic transfer onto a plurality of magnetic recording media in a short time becomes difficult.

Consequently, with the foregoing problems of the prior art in view, an object of the present invention is to provide a magnetic disk production method and magnetic pattern replication apparatus that can more efficiently conduct magnetic transfer of master information patterns onto magnetic recording medium that is a more compact magnetic recording medium.

In a magnetic disk production method having the steps of bringing a master information carrier, on which magnetic patterns corresponding to information are formed, into the proximity of a magnetically recordable disk-shaped magnetic recording medium, and of replicating the aforementioned magnetic patterns on the aforementioned magnetic recording medium, a first aspect of the present invention to achieve the aforementioned objectives has the steps of: forming on one surface of the master information carrier a plurality of magnetic patterns corresponding to the information that is to be recorded on a disk-shaped magnetic recording medium having a diameter smaller than that of the aforementioned master information carrier; bringing into contact and aligning the aforementioned magnetic recording medium with the respective plurality of magnetic patterns formed on one surface of the aforementioned master information carrier; and applying direct current magnetic fields corresponding respectively to the aforementioned plurality of magnetic patterns to transfer the aforementioned plurality of magnetic patterns formed on the master information carrier onto the aforementioned contacting and aligned disk-shaped magnetic recording media corresponding to the respective aforementioned magnetic patterns.

In the aforementioned first aspect, when bringing into contact and aligning the aforementioned magnetic recording medium with the respective plurality of magnetic patterns formed on one surface of the aforementioned master information carrier, the master information carrier on which the aforementioned plurality of magnetic patterns are formed is taken to be a first master information carrier, and a second master information carrier having a magnetic pattern corresponding to one magnetic recording medium is brought from the side opposite the aforementioned first master information carrier into contact with a magnetic recording medium, which is contacting and aligned with the aforementioned first master information carrier, and a direct current magnetic field is applied to transfer the aforementioned magnetic patterns to both sides of the aforementioned magnetic recording medium.

In a magnetic disk production method having the steps of bringing a master information carrier, on which magnetic patterns corresponding to information are formed, into the proximity of a disk-shaped magnetic recording medium that can magnetically record information, and of replicating the aforementioned magnetic patterns on the aforementioned magnetic recording medium, a second aspect of the present invention to achieve the aforementioned objectives has the steps of: forming on one surface respectively of first and second master information carriers plurality of magnetic patterns corresponding to information that is to be recorded on the disk-shaped magnetic medium with a smaller diameter than that of the aforementioned master information carrier; bringing into contact and aligning the aforementioned magnetic recording media in plurality sandwiched between the aforementioned first and second master information carriers when the plurality of magnetic recording media are positioned corresponding respectively to the plurality of magnetic patterns formed on the aforementioned first and second master information carriers; and applying direct current magnetic fields from the other surface sides of the aforementioned first and second master information carriers to transfer the plurality of magnetic patterns formed on the aforementioned first and second master information carriers onto both surfaces respectively of the aforementioned plurality of magnetic recording media.

In a magnetic pattern replication apparatus in which a master information carrier, on which magnetic patterns corresponding to information are formed, is brought into the proximity of a magnetically recordable disk-shaped magnetic recording medium, and the aforementioned magnetic patterns are replicated on the aforementioned magnetic recording medium, a third aspect of the present invention to achieve the aforementioned objectives has: a master information carrier which has a diameter greater than that of the aforementioned magnetic recording medium, and on which a plurality of magnetic patterns corresponding to information that is to be recorded on the magnetic recording medium are formed at a predetermined angular spacing on one surface; a magnetic field generator that imparts to the aforementioned master information carrier a direct current magnetic field in relation to the respective plurality of magnetic patterns formed on the aforementioned one surface; and a mechanism to bring into contact and align the aforementioned magnetic recording medium with the respective the plurality of magnetic patterns corresponding to the aforementioned information formed on the aforementioned master information carrier; wherein plurality of master information patterns formed on the master information carrier are transferred to corresponding contacted and aligned magnetic recording media by applying direct current magnetic fields respectively.

In the aforementioned third aspect, the mechanism that brings into contact and aligns the aforementioned magnetic recording medium to the respective aforementioned plurality of magnetic patterns has a first master information carrier, which is the aforementioned master information carrier on which the plurality of magnetic patterns are formed; a second master information carrier, which has a magnetic pattern corresponding to one magnetic recording medium; a head unit provided with a magnetic field generator that imparts the aforementioned direct current magnetic field; and a control unit that moves and controls the aforementioned head unit; wherein the aforementioned control unit supports the aforementioned magnetic recording medium by the second master information carrier which is associated with the medium, and moves and controls the aforementioned magnetic recording medium to a magnetic pattern position of the aforementioned first master information carrier.

Further, in the aforementioned third aspect, the aforementioned second master information carrier has plurality of suction holes, and is configured to suction up and retain the aforementioned magnetic recording medium through the aforementioned plurality of suction holes.

Moreover, in the aforementioned third aspect, the plurality of magnetic patterns formed on the aforementioned first and second master information carriers are arranged circularly in spaces of a predetermined angle corresponding to the aforementioned disk-shaped magnetic recording medium; adjacent magnetic patterns are respectively formed by a positive pattern and a negative pattern; the magnetic field generator that applies the aforementioned direct current magnetic field comprises plurality of individual magnets arranged circularly corresponding the aforementioned disk-shaped magnetic recording medium; and the respective aforementioned plurality of single magnets arranged circularly are positioned corresponding respectively to the aforementioned magnetic patterns, and adjacent single magnets have opposite magnetic polarities.

In the magnetic pattern replication apparatus above, the magnetic field generator that applies the direct current magnetic field is embedded in a substrate at a position corresponding to the plurality of magnetic patterns formed in the aforementioned first and second magnetic information carriers, and is arranged to make contact with the aforementioned first and second master information carriers.

Further in the first to third aspects above, the information to which the aforementioned magnetic patterns correspond is servo information used to determine the position of the magnetic head of a hard disk apparatus.

The present invention provides a magnetic pattern replication apparatus that is suitable for high-density, compact small diameter magnetic recording medium, and for which a master information carrier is easily prepared.

### BRIEF DESCRIPTION OF THE DRAWINGS

FIG. 1 is a schematic diagram indicating the top surface of one magnetic recording medium;

FIG. 2 indicates an example of a master information pattern;

FIG. 3 is a conceptual perspective diagram of a magnetic pattern replication apparatus using the conventional method of replicating magnetic patterns disclosed in Japanese Patent Application Publication No. H10-40544 and Japanese Patent Application Publication No. 2003-272143;

FIG. 4 is a conceptual diagram of the cross-section along the A-A′ line n FIG. 3;

FIG. 5 indicates the top surface of an example of a master information carrier according to the present invention;

FIG. 6 indicates the magnetic material part of a magnetic pattern corresponding to the master information pattern for a small diameter disk;

FIG. 7 is a conceptual diagram of an embodiment based on the principle of the present invention;

FIG. 8 indicates a cross-sectional diagram of the state when the head unit of the handling mechanism is positioned at one of the plurality of master information patterns corresponding to a small diameter disk of the master information carrier;

FIG. 9 indicates the planar surface shape of the master information carrier built into the head unit of the handling mechanism;

FIG. 10 indicates the structure on the back side of the master information carrier of an embodiment of the replication magnetic field generator for imparting an excitation magnetic field when replicating;

FIG. 11 indicates a cross-sectional diagram along the A-A′ line in FIG. 10; and

FIG. 12 indicates the configuration of an embodiment of another replication magnetic field generator.

### DESCRIPTION OF THE PREFERRED EMBODIMENTS

Embodiments of the present invention will be explained below following the diagrams. Further, the embodiments are for understanding the present invention, and the technological scope of the present invention is not limited thereby.

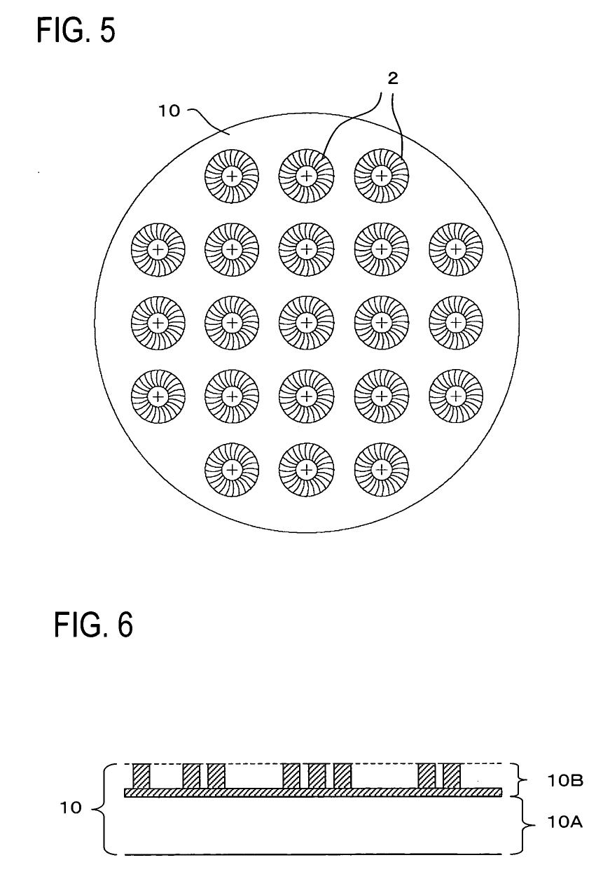

FIG. 5 is a diagram indicating the top plan view of an example of a master information carrier 10 according to the present invention.

For example, magnetic patterns, each corresponding to the master information pattern 2 for small diameter disks, such as 1-inch diameter compact disks, are formed on an 8-inch diameter silicon, glass, plastic, or metallic such as Al substrate 10.

FIG. 6 is a diagram to explain the form of the related magnetic material part, and indicates a partial cross-section of the master information carrier 10 in the track direction patterned corresponding to one small diameter disk.

For example, as indicated in FIG. 5, an 8-inch diameter silicon substrate is used as the master information carrier 10. A suitable conventional method such as, for example, sputtering, vacuum deposition, or CVD is used to form a strong magnetic material film 10B on the silicon substrate 10A.

Then, the strong magnetic material film 10B is formed into contoured patterning corresponding to multiple master information patterns 2 for small diameter disks by subjecting the strong magnetic material film 10B to the microprocessing, for example, lithography, used in semiconductor processing, etc.

Moreover, as another method, the contouring corresponding to the master information patterns 2 may also be formed on the silicon substrate 10A first by conducting semiconductor processing such as etching, and then forming a strong magnetic material film thereon.

The master information carrier 10 according to the present invention having the magnetic material part 10B in contoured patterns corresponding to the master information patterns 2 is thereby obtained.

Compared to the conventional examples described earlier, this master information carrier 10 is characterized by multiple master information patterns 2 for small diameter disks being arranged on the master information carrier 10, which is a large main master substrate.

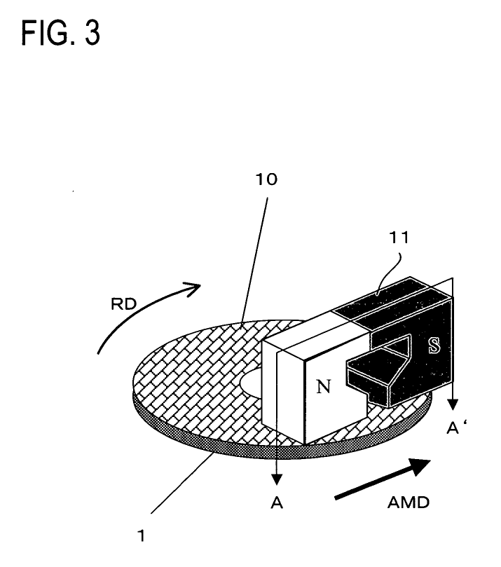

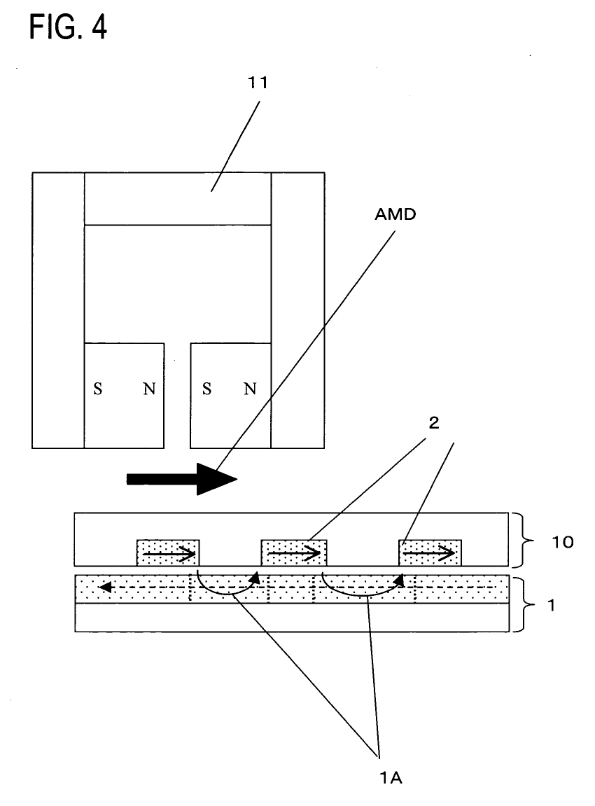

As a method to replicate and transfer the master information pattern 2 for small diameter disks using such a master information carrier 10 according to the present invention, it is possible to bring into contact and align multiple small diameter disks (magnetic recording media) corresponding to the positions of the multiple master information patterns 2 for small diameter disks of the master information carrier 10, and to magnetically transfer the master information patterns 2 to multiple (21 disks in the example indicated in FIG. 5) small diameter disks at one time by applying a direct current magnetic field for excitation from the back surface side of the master information carrier 10 as previously explained in FIG. 3 and FIG. 4.

Further, if the master information patterns 2 are magnetically transferred to both sides of a small diameter disk, it is possible to provide magnetic fields for excitation from the upper and lower sides by sandwiching between identical master information carriers 10 multiple small diameter disks contacting and aligned with the positions of the master information patterns 2 for multiple small diameter disks of the master information carriers 10.

However, when assuming a magnetic transfer mechanism corresponding to the related method, a handling mechanism to align multiple small diameter disks on one master information carrier 10, a master information carrier 10 handling mechanism to cover the upper side with another master information carrier 10, and a magnetic mechanism to impart a magnetic field for excitation from outside of the upper and lower master information carriers 10 are necessary.

On this point, the magnetic pattern replication apparatus requires a complicated mechanism. Further, processing time to arrange the multiple small diameter disks on the master information carrier 10, and processing time to cover the aligned small diameter disks with another master information carrier 10 will be required.

Consequently, it may be expected that the greater the number of small diameter disks arranged on the master information carrier 10, the more complicated the apparatus mechanism will be, and the longer the time required for replication of the magnetic pattern will be.

Consequently, as a preferable embodiment of the present invention, the related anticipated disadvantage may be resolved by incorporating into the handling mechanism unit, which aligns the small diameter disks on the master information carrier 10, a master information pattern corresponding to the upper surface side of the small diameter disk, and an excitation mechanism required for replicating the magnetic pattern.

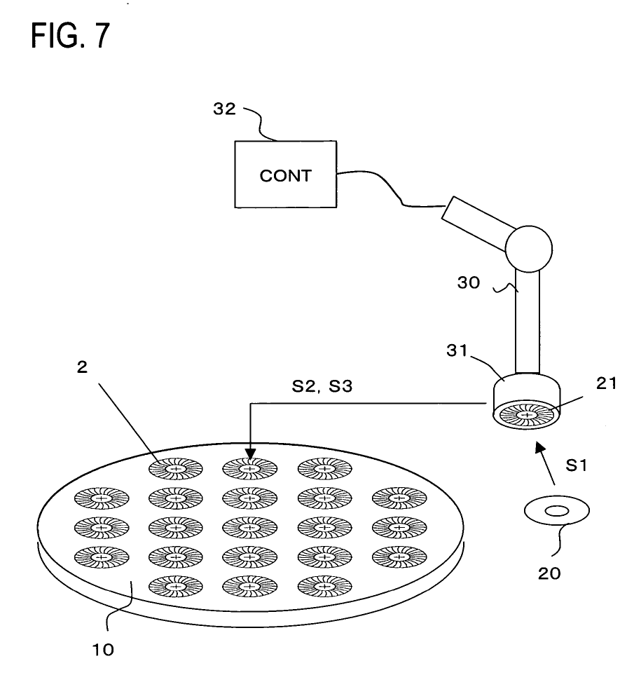

FIG. 7 is a conceptual diagram of an embodiment based on the related principle of the present invention.

In FIG. 7, multiple master information patterns 2 corresponding to small diameter disks are formed on the master information carrier 10 as explained by FIG. 5.

Meanwhile, a handling mechanism 30 has a head unit 31. By a suitable position control mechanism, it is possible to use a control unit 32 through the handling mechanism 30 to move and control the head unit 31 to the stipulated position of the master information carrier 10, specifically, to the respective positions where multiple master information patterns 2 corresponding to small diameter disks are formed.

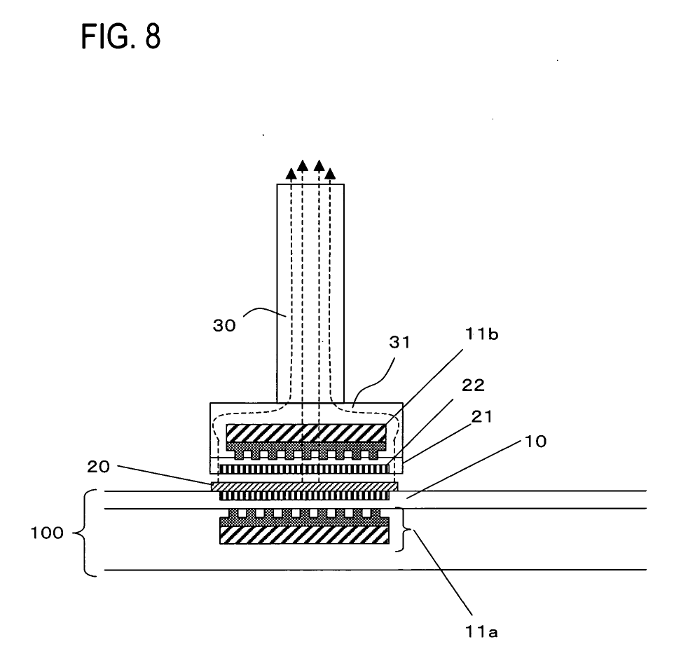

FIG. 8 indicates a cross-sectional diagram of the state when the head unit 31 of the handling mechanism 30 is positioned at one of the multiple master information patterns 2 corresponding to a small diameter disk of the master information carrier 10.

Here, a main master substrate unit 100 has a master information carrier 10 and a layer in which a pattern replication magnetic field generator 11a is embedded on the lower side of the master information carrier.

The pattern replication magnetic field generator 11a is embedded on the lower side corresponding to a master information pattern 2 corresponding to one small diameter disk formed on the master information carrier 10.

Meanwhile, a master information carrier 21 corresponding to one small diameter disk, and a pattern replication magnetic field generator 11b corresponding to the upper side thereof are built into the head unit 31 of the handling mechanism 30.

When transferring the master information pattern 2, a small diameter disk 20, which is a magnetic recording medium, is brought into contact with and aligned on top of the master information carrier 10. Further, the head unit 31 of the tube-shaped handling mechanism 30 is brought into contact with and positioned on the upper surface side of the small diameter disk 20.

Then, for the lower surface side of the small diameter disk 20, a magnetic field is imparted by the pattern replication magnetic field generator 11a, and the master information pattern 2 for small diameter disks formed on the master information carrier 10 is transferred to the lower surface side of the small diameter disk 20.

At the same time, to the upper surface side of the small diameter disk 20, a magnetic field is imparted by the pattern replication magnetic field generator 11b in the head unit 31 of the handling mechanism 30, and the master information pattern 2 for small diameter disks formed on the master information carrier 21 is transferred to the upper surface side of the small diameter disk 20.

Here, the action of the head unit 31 of the handling mechanism 30 to position the small diameter disk onto the master information pattern 2 on the master information carrier 10 will be explained.

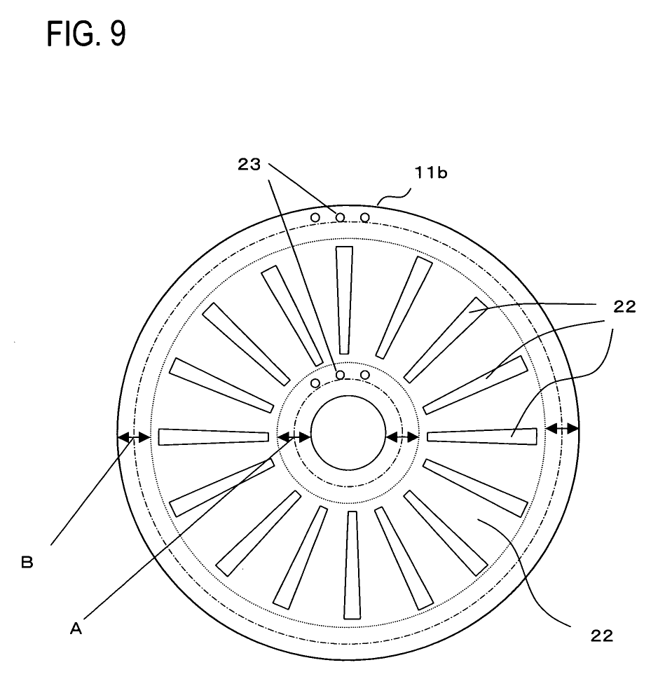

The top surface shape of the master information carrier 21 built into the head unit 31 of the handling mechanism 30 is as indicated in FIG. 9, and multiple suction holes 23 with a width of approximately 1 mm are concentrically formed on a central circumferential unit A and an outer circumferential unit B respectively, making a diameter of approximately 1 inch corresponding to the diameter of the small diameter disk 20.

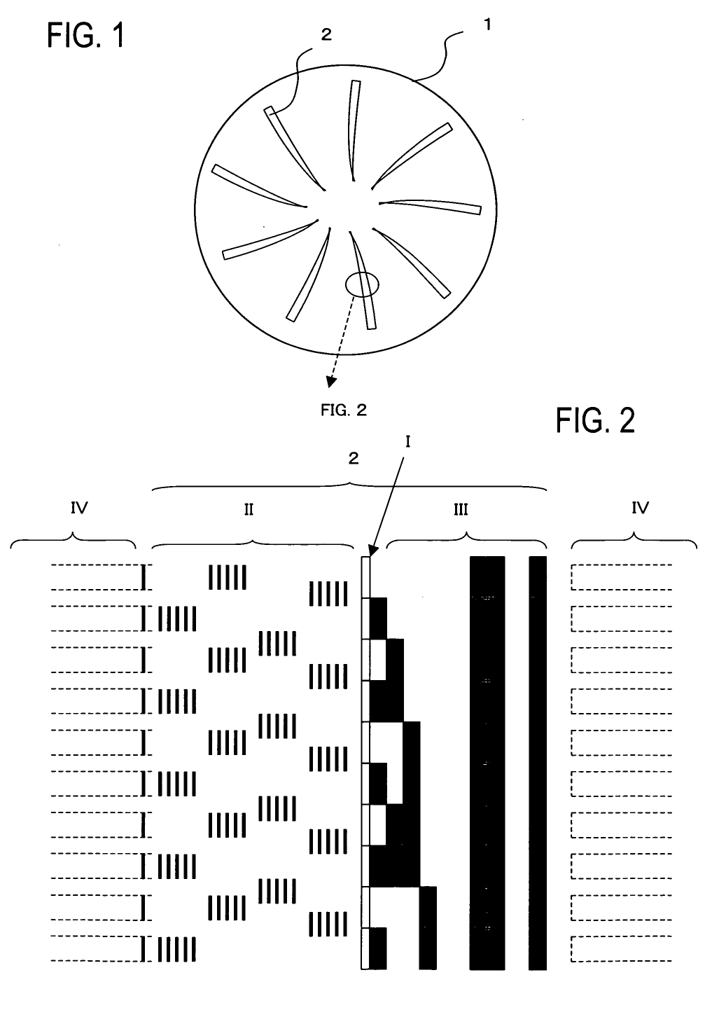

Suction force in the direction of the dotted line arrow (refer to FIG. 8) is applied to these multiple suction holes 23 through the tube-shaped handling mechanism 30. Then, as explained by FIG. 1, the magnetic pattern 22 corresponding to the master information patterns 2 required for tracking are formed at every stipulated angle onto the region 22, which is between the central circumferential unit A and the outer circumferential unit B, and which corresponds to the recording region of the small diameter disk 20.

The formation of the magnetic pattern 22 corresponding to this master information pattern 2 is the same as that previously explained regarding the master information carrier 10 using FIG. 6.

The movement when magnetically transferring the master information pattern 2 to both sides of the small diameter disk 20 based on the related mechanism will be explained below.

The control unit 32 moves and controls though the handling mechanism 30 such that the head unit 31 faces the position of the stock of small diameter disks 20, which are the magnetic recording medium not indicated in the diagram. At the stock position of the small diameter disks 20, when suction pressure is applied through the suction holes 23 of the master information carrier 21, one of the stocked small diameter disks 20 is suctioned up and retained on the head unit 31 (step S1).

Next, the head unit 31 with the small diameter disk 20 retained by suction is placed at the position of the individual master information patterns 2 for small diameter disks on the master information carrier 10 (step S2).

After aligning to the position of a master information pattern 2 on the master information carrier 10, the small diameter disk is brought into contact with the master information carrier 10 and the master information carrier 21, and the master information patterns 2 are transferred (step S3).

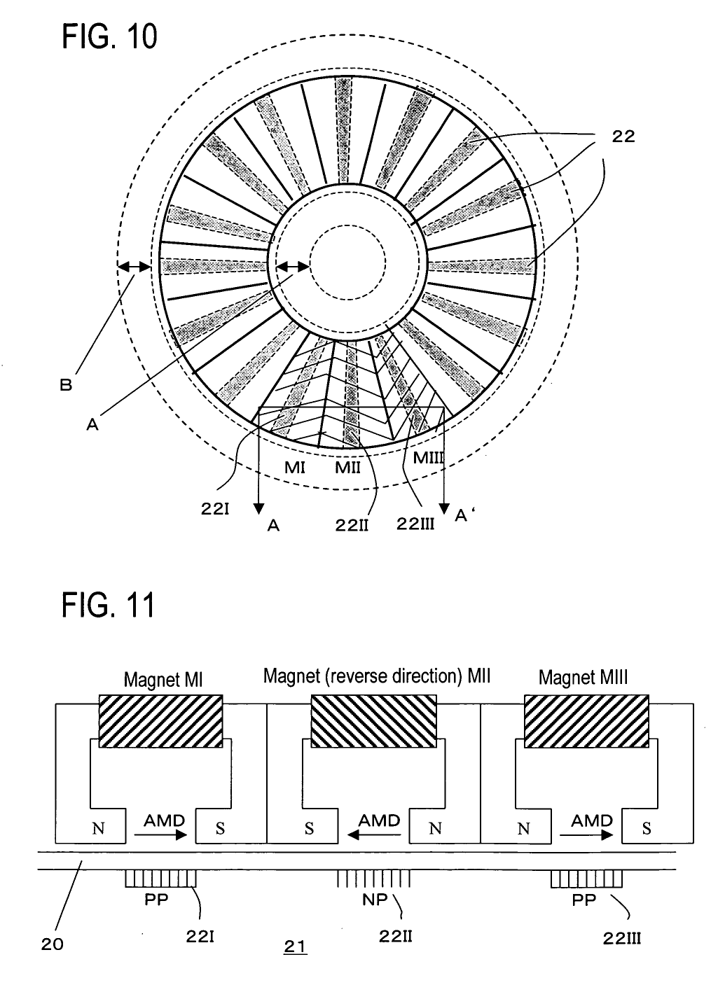

FIG. 10 indicates the structure on the back surfaces of the master information carriers 10 and 21 of an embodiment of a replication magnetic field generator 11a and a replication magnetic field generator 11b for imparting an excitation field when replicating. As an example, the replication magnetic field generator 11b with the reference numbers arranged on the back surface of the master information carrier 21 will be explained.

Replication magnetic field generator 11b comprises a magnet formed in a donut shape in a region that excludes the center A and periphery B. This donut-shaped magnet is divided into multiple parts corresponding to the positions of the master information patterns 22, and is formed such that the magnetic polarities of adjacent magnets are the same.

These circumstances can be easily understood in FIG. 11, which is a cross-sectional diagram along the A-A′ line in FIG. 10.

The directions of the excitation magnetic fields AMD of the three magnets MI, MII, and MIII in the cross-sectional part along the A-A′ line are the opposite of the directions of the adjacent magnets.

The reason is that excitation magnets for a small diameter disk cannot be arranged with adequate spacing, and therefore heteropolaric magnets are placed adjacent to each other so that magnetic circuits cannot form in relation to the respective positions of the master information patterns 22.

Therefore, as indicated in FIG. 11, the logic of the adjacent master information patterns 22I, 22II, and 221III that are formed on the master information carrier 21 must be formed such that the positive pattern PP and the negative pattern NP alternate.

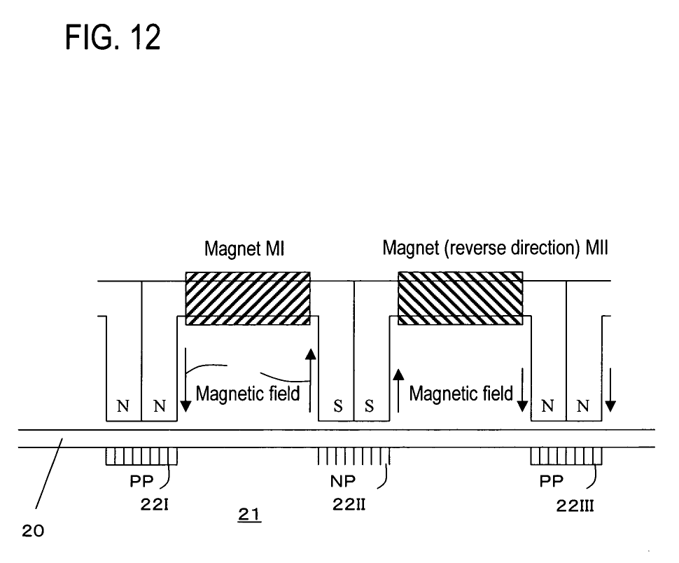

FIG. 12 is another configuration of an embodiment of a replication magnetic field generator 11a and a replication magnetic field generator 11b, and is an example of providing a perpendicular magnetic field in relation to the master information carriers 10 and 21. In this case as well, adjacent magnets MI and MII are set up so that the directions of the magnetic fields are opposite each other. Then, in this case as well, the logic of the master information patterns 2 and 22 formed on the master information carriers 10 and 21 are formed such that the positive pattern PP and the negative pattern NP alternate at adjacent master information positions 22I, 22II, and 22III.

In the examples of the replication magnetic field generator 11a and a replication magnetic field generator 11b explained above in FIG. 10 through FIG. 12, rotation of the magnet is not necessary, and therefore, a static magnetic generator can be configured.

Further, examples of using magnets as the replication magnetic field generator 11a and a replication magnetic field generator 11b were explained above, but of course, a configuration with electromagnets instead of magnets is also possible.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A magnetic pattern replication method for a magnetic disk production, in which a master information carrier on which magnetic patterns are formed corresponding to information, is brought into the proximity of a magnetically recordable disk-shaped magnetic recording medium, so that the magnetic patterns is replicated on the magnetic recording medium, the magnetic pattern replication method comprising the steps of:
forming on one surface of the master information carrier a plurality of magnetic patterns corresponding to the information that is to be recorded on the disk-shaped magnetic recording medium having a diameter smaller than that of said master information carrier;
bringing into contact and aligning said magnetic recording medium with the respective plurality of magnetic patterns formed on one surface of said master information carrier; and
applying direct current magnetic fields corresponding respectively to said plurality of magnetic patterns to transfer said plurality of magnetic patterns formed on the master information carrier onto said contacting and aligned disk-shaped magnetic recording media corresponding to the respective said magnetic patterns.

2. The magnetic pattern replication method according to claim 1, wherein
when bringing said magnetic recording media into contact and aligning with the respective plurality of magnetic patterns formed on one surface of said master information carrier,
the master information carrier on which said plurality of magnetic patterns are formed is taken to be a first master information carrier, and
a second master information carrier having a magnetic pattern corresponding to one magnetic recording medium is brought from the side opposite said first master information carrier into contact with a magnetic recording medium, which is contacting and aligned with said first master information carrier, and a direct current magnetic field is applied to transfer said magnetic patterns to both sides of said magnetic recording medium.

3. A magnetic pattern replication method for a magnetic disk production, in which a master information carrier on which magnetic patterns are formed corresponding to information, is brought into the proximity of a magnetically recordable disk-shaped magnetic recording medium, so that the magnetic patterns is replicated on the magnetic recording medium, the magnetic pattern replication method comprising the steps of:
forming on one surface respectively of first and second master information carriers a plurality of magnetic patterns corresponding to information that is to be recorded on the disk-shaped magnetic medium with a smaller diameter than that of said master information carrier;
bringing into contact and aligning said magnetic recording media in plurality placed between said first and second master information carriers when the plurality of magnetic recording media are positioned corresponding respectively to the plurality of magnetic patterns formed on said first and second master information carriers; and
applying direct current magnetic fields from the other surface sides of said first and second master information carriers to transfer the plurality of magnetic patterns formed on said first and second master information carriers onto both surfaces respectively of said plurality of magnetic recording media.

4. The magnetic pattern replication method according to claim 1, wherein
the information to which said magnetic pattern corresponds is servo information used in order to determine the position of the magnetic head of a hard disk apparatus.

5. The magnetic pattern replication method according to claim 2, wherein
the information to which said magnetic pattern corresponds is servo information used in order to determine the position of the magnetic head of a hard disk apparatus.

6. The magnetic pattern replication method according to claim 3, wherein
the information to which said magnetic pattern corresponds is servo information used in order to determine the position of the magnetic head of a hard disk apparatus.

7. A magnetic pattern replication apparatus in which a master information carrier, on which magnetic patterns corresponding to information are formed, is brought into the proximity of a magnetically recordable disk-shaped magnetic recording medium, and said magnetic patterns are replicated on said magnetic recording medium,
the magnetic pattern replication apparatus comprising:
a master information carrier which has a diameter greater than that of said magnetic recording medium, and on which a plurality of magnetic patterns corresponding to information that is to be recorded on the magnetic recording medium are formed at a predetermined angular spacing on one surface;
a magnetic field generator that imparts to said master information carrier a direct current magnetic field in relation to the respective magnetic patterns formed on said one surface; and
a mechanism to bring into contact and align said magnetic recording medium with the respective the plurality of magnetic patterns corresponding to said information formed on said master information carrier,
wherein the plurality of master information patterns formed on the master information carrier are transferred to corresponding contacted and aligned magnetic recording media by applying direct current magnetic fields respectively.

8. The magnetic pattern replication apparatus according to claim 7, wherein
the mechanism that brings into contact and aligns said magnetic recording medium to the respective plurality of magnetic patterns comprises:
a first master information carrier, which is said master information carrier on which the plurality of magnetic patterns are formed;
a second master information carrier, which has a magnetic pattern corresponding to one magnetic recording medium;
a head unit provided with a magnetic generator that imparts said direct current magnetic field; and
a control unit that moves and controls said head unit, wherein
said control unit supports said magnetic recording medium by the second master information carrier which is associated with the medium, and moves and controls said magnetic recording medium to a magnetic pattern position of said first master information carrier.

9. The magnetic pattern replication apparatus according to claim 8, wherein
said second master information carrier has a plurality of suction holes, and is configured to suction up and retain said magnetic recording medium through said plurality of suction holes.

10. The magnetic pattern replication apparatus according to claim 7, wherein
the plurality of magnetic patterns formed on said first and second master information carriers are arranged circularly in spaces of a predetermined angle corresponding to said disk-shaped magnetic recording medium;
adjacent magnetic patterns are respectively formed by a positive pattern and a negative pattern;
the magnetic field generator that applies said direct current magnetic field comprises a plurality of single magnets arranged circularly corresponding said disk-shaped magnetic recording medium; and
the respective plurality of single magnets arranged circularly are positioned corresponding respectively to said magnetic patterns, and adjacent single magnets have opposite magnetic polarities.

11. The magnetic pattern replication apparatus according to claim 8, wherein
the plurality of magnetic patterns formed on said first and second master information carriers are arranged circularly in spaces of a predetermined angle corresponding to said disk-shaped magnetic recording medium;
adjacent magnetic patterns are respectively formed by a positive pattern and a negative pattern;
the magnetic field generator that applies said direct current magnetic field comprises a plurality of single magnets arranged circularly corresponding said disk-shaped magnetic recording medium; and
the respective plurality of single magnets arranged circularly are positioned corresponding respectively to said magnetic patterns, and adjacent single magnets have opposite magnetic polarities.

12. The magnetic pattern replication apparatus according to claim 7, wherein
the magnetic field generator that applies the direct current magnetic field is embedded in a substrate at a position corresponding to the plurality of magnetic patterns formed in said first and second magnetic information carriers, and is arranged to make contact with said first and second master information carriers.

13. The magnetic pattern replication apparatus according to claim 8, wherein
the magnetic field generator that applies the direct current magnetic field is embedded in a substrate at a position corresponding to the plurality of magnetic patterns formed in said first and second magnetic information carriers, and is arranged to make contact with said first and second master information carriers.

14. The magnetic pattern replication apparatus according to claim 7, wherein the information to which said magnetic patterns correspond is servo information used to determine the position of the magnetic head of a hard disk apparatus.

15. The magnetic pattern replication apparatus according to claims 8, wherein the information to which said magnetic patterns correspond is servo information used to determine the position of the magnetic head of a hard disk apparatus.
